(19) United States
(12) Patent Application Publication
(10) Pub. No.: US 2004/0229015 A1
(43) Pub. Date: Nov. 18, 2004

(54) POLYMERIC COMPONENT HAVING REDUCED GLOSS APPEARANCE AND METHOD OF PRODUCING SAME

(76) Inventors: Roy Gibbs I, Plymouth, MI (US); Gary Zaleski, Rochester Hills, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/709,563

(22) Filed: May 13, 2004

Related U.S. Application Data
(60) Provisional application No. 60/469,959, filed on May 13, 2003.

(51) Int. Cl. B32B 1/00

(52) U.S. Cl. 428/141

(57) ABSTRACT

A method for producing a polymeric component having a surface with a reduced gloss appearance is provided. A mold tool has a surface that includes a plurality of raised portions configured in a tool surface pattern. Each of the raised portions has a maximum width, and the average maximum width of the raised portions is less than 350 μm. A polymeric material is disposed within the mold tool such that at least some of the polymeric material contacts the tool surface. This forms in the polymeric material a corresponding surface having a pattern of cavities that generally match the tool surface pattern. The corresponding surface of the polymeric component has a reduced gloss appearance, resulting, at least in part, from the cavities formed by the raised portions of the mold tool.

### CROSS REFERENCE TO RELATED APPLICATIONS

This application claims the benefit of U.S. provisional application Serial No. 60/469,959 filed May 13, 2003.

### BACKGROUND OF INVENTION

1. Field of the Invention

The present invention relates to a polymeric component having a surface with a reduced gloss appearance, and a method of producing such a component.

2. Background Art

Polymeric materials are used today in an ever increasing number of different applications. Whether it is in a structural application, or one designed primarily for aesthetics, the use of polymeric materials often provides a light weight and less expensive alternative to materials such as metals. The use of polymeric materials in vehicles is one example. Some body components, traditionally made from metal, may now be made from polymeric materials, thereby reducing vehicle cost while providing manufacturing flexibility. In addition, interior components, such as headliners and trim panels provide a number of benefits, including adding to the aesthetics of the vehicle interior. When a polymeric component is produced, it may have a naturally high gloss appearance. This may be desirable in some situations, where a highly reflective surface is considered aesthetically pleasing. Conversely, a high gloss finish on the surface of a component may be undesirable in an area such as an instrument panel or dashboard, because the reflective surface may reduce driver visibility.

One method of inhibiting a high gloss finish on a polymeric component is to blast the interior surface of a mold tool that is used to produce the component. Abrasive materials, such as aluminum oxide, can be applied at high pressure to a surface of a mold tool that produces an exterior surface of a polymeric component. Commonly known as “bead blasting”, this technique imparts many indentations to the surface of the mold, which in turn, may provide a reduced gloss finish on a corresponding surface of a polymeric component. One limitation of this technique is that the indentations provided by the bead blasting quickly become filled with polymeric material residue during repeated use of the mold tool. Therefore, in order to remain effective, the tool must be repeatedly blasted to ensure that the surface of the mold tool remains sufficiently abraded to provide the reduced gloss finish on the polymeric component. This increases downtime and adds to labor costs. Moreover, the bead blasting process is subject to a great deal of variation if it is performed by a human operator, and it may be cost prohibitive and unnecessarily complex if the process is fully automated.

Therefore, a need exists for a method of consistently producing a polymeric component having a surface with a reduced gloss appearance.

### SUMMARY OF INVENTION

Accordingly, the present invention provides a method for consistently producing a polymeric component having a surface with a reduced gloss appearance.

The invention also provides a method for producing a mold tool to achieve a reduced gloss appearance on a surface of a polymeric component produced with the tool. The method includes masking a portion of a surface of the tool with a plurality of characters arranged in a character pattern. A caustic material is applied to the tool surface, thereby removing material from an unmasked portion of the tool surface, and leaving the masked portion raised above the unmasked portion and forming a tool surface pattern generally matching the character pattern. The tool surface pattern includes a plurality of raised portions. Each of the raised portions has a maximum width, and the average maximum width of the raised portions is less than 350 μm. The tool surface pattern thereby provides a reduced gloss appearance on a corresponding surface of a polymeric component produced with the tool.

The invention further provides a method for producing a polymeric component having a surface with a reduced gloss appearance. The method includes providing a mold tool having a surface including a plurality of raised portions configured in a tool surface pattern. Each of the raised portions has a maximum width, and the average maximum width of the raised portions is less than 350 μm. A polymeric material is disposed within the mold tool such that at least some of the polymeric material contacts the tool surface. This forms in the polymeric material a corresponding surface having a pattern generally matching the tool surface pattern and having a reduced gloss appearance.

The invention also provides a polymeric component having a reduced gloss appearance. The polymeric component includes a surface and a plurality of cavities formed in at least a portion of the surface. Each of the cavities has a maximum width, and the average maximum width of the cavities is less than 350 μm. The cavities have a density greater than 6,000 cavities per square inch, thereby providing a reduced gloss appearance on the surface.

### BRIEF DESCRIPTION OF DRAWINGS

FIG. 1 is a flow chart illustrating steps in accordance with a method of the present invention;

FIGS. 2A and 2B are fragmentary plan views of a portion of a mold tool including a plurality of raised portions configured to provide a low gloss appearance on a corresponding surface of a polymeric component produced with the mold tool; and

FIG. 3 is a fragmentary plan view of a portion of an automotive trim component, including a plurality of cavities formed by raised portions within a mold tool, and further including an aesthetic pattern formed with the same mold tool.

### DETAILED DESCRIPTION

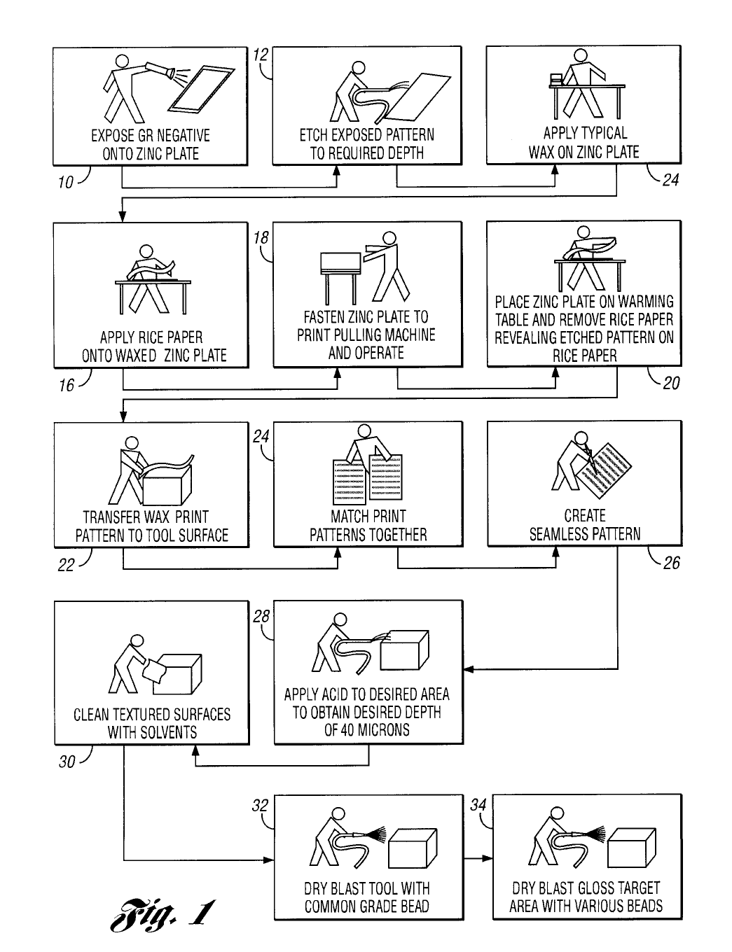

FIG. 1 shows a process flow chart illustrating a method for producing a mold tool to achieve a reduced gloss appearance on a surface of a polymeric component produced with the tool. As used herein, the term “reduced gloss appearance” means that a surface of a component has a lower gloss appearance as a result of certain processing steps, than the same component would have if the certain processing steps were omitted. Thus, the present invention may be used in a wide variety of applications, each of which may have a different gloss requirement. Some gloss requirements may be quantified, for example, by using a veiling glare index (VGI). Alternatively, a gloss requirement may be specified by a visual inspection, comparing a production component to an agreed upon standard. In either case, the present invention provides a method for lowering the gloss on a surface of a polymeric component.

To achieve the reduced gloss appearance on the surface of the polymeric component, the present invention generally contemplates providing a mold tool having a plurality of raised portions arranged in a pattern, which for convenience, may be called a tool surface pattern. As explained more fully below, the raised portions may have various sizes, though the use of raised portions having an average maximum width less than 350 μm has been found to be effective to reduce the gloss on a surface of a polymeric component. To produce the component, polymeric material is then disposed within the mold tool such that at least some of the polymeric material contacts the tool surface. This forms in the component a corresponding surface having a pattern generally matching the tool surface pattern; the gloss on the corresponding surface of the component is thereby reduced. Because the mold tool surface is effectively a negative of the component surface, the polymeric component will have a plurality of cavities formed therein, which help to reduce reflection of light that strikes the surface of the component.

One method of achieving the reduced gloss appearance on a polymeric component in accordance with the present invention is illustrated in FIG. 1. At step 10, a gloss reduction (GR) negative is placed onto a metallic plate, such as a zinc plate. The zinc plate has been covered with photosensitive material, as is well known in the mold tool industry. The GR negative is a translucent film having opaque characters thereon. These characters are of a size and shape, and are arranged in a pattern, generally matching the size, shape and pattern of the raised portions to be formed on the mold tool surface. After the GR negative is placed onto the zinc plate, the surface of the zinc plate having the photosensitive material is exposed to a light to cure the material and form a “baked-on” coating on the surface of the zinc plate. Because the GR negative contains opaque characters, the photosensitive material will not be cured in those areas that were covered by the characters. Therefore, when the zinc plate is placed into a developing solution, the uncured photo sensitive material will be washed away, while the cured portion of the coating will remain.

At this point, the zinc plate has a pattern of exposed areas generally matching the size and shape of what will later be the raised portions on the mold tool. At step 12, the zinc plate is etched with a caustic material to form a plurality of cavities in the zinc plate. The cavities are formed in the exposed portion of the zinc plate, in a pattern corresponding to the character pattern on the GR negative. Although any caustic material effective to produce the cavities may be used, using ferric chloride acid to remove material from the zinc plate at a rate of approximately 25 μm per three minutes has been found to be effective. The rate of material removal is a function of such things as the acid concentration and the temperature of the solution. Removing material at different rates has different effects on the cavities. For example, removing material at a slower rate forms cavities having edges which are less sharp than those formed at more aggressive rates. As an alternative to the acid etching, cavities may be formed in the zinc plate using a laser, or by other techniques effective to remove material and form the cavities.

At step 14, the cavities are filled with a spreadable material, such as a paraffin wax. The wax is scraped across the surface of the zinc plate to fill the cavities. In scraping the zinc plate surface, some of the wax may be pulled from one or more of the cavities, such that the cavities will be at least partially filled, though each of the cavities may not be completely filled to the surface of the zinc plate. At step 16, a paper, such as rice paper, is applied to the zinc plate over the cavities in the surface. At this point, the paper may be rubbed onto the zinc plate manually, or, as shown in step 18, the zinc plate with the paper attached may be placed in a print pulling machine. The print pulling machine applies pressure to the rice paper/zinc plate combination, and provides a more consistent application than manually rubbing the rice paper.

At step 20, the zinc plate is placed on a warming table to soften the wax within the cavities. The rice paper is then removed, which removes at least some of the wax from the cavities in the zinc plate. The rice paper now has a pattern of wax characters having a size and shape corresponding to the characters on the GR negative. The height of the wax characters on the rice paper is likely to be somewhat less than the depth of the cavities in the zinc plate. For example, if each of the cavities has a maximum depth, and the average maximum depth of the cavities in the zinc plate is approximately 37 μm, the average height of the characters on the wax paper may be approximately 23 μm. This disparity reflects the fact that some of the wax may be pulled from the cavities when the surface of the zinc plate is scraped, and also that some of the wax may remain in the cavities when the rice paper is removed from the zinc plate.

After the rice paper is removed, it is transferred to the surface of a mold tool—see step 22. Depending on the component to be produced, the mold tool may be larger than a single waxed rice paper can cover. In such a case, more than one waxed rice paper may be used to cover the surface of the mold tool. At step 24, two different pieces of rice paper, each containing wax characters, are lined up so that the patterns flow seamlessly from one piece of rice paper to the other. At this point, the rice paper can be soaked with a liquid solution, such as water and alcohol, so that the paper can be removed, leaving only the wax characters on the surface of the mold tool. In case manual adjustment is needed, step 26 may be optionally used to create a seamless pattern between the two or more patterns of wax characters. To achieve this, any convenient acid resistant material can be used to create a seamless pattern over the surface of the mold tool.

The wax that remains on the surface of the mold tool, as well as any additional acid resistant material applied at step 26, effectively masks the mold tool surface with a plurality of characters that are arranged in a character pattern generally matching the pattern of the GR negative. There will, of course, be some variation between the pattern of characters on the GR negative and the character pattern on the surface of the mold tool. For example, as noted above, etching the zinc plate can be done in a number of different ways, such that the cavities in the zinc plate may have slight differences from the pattern of characters on the GR negative. Similarly, when the rice paper is removed from the zinc plate, the resulting pattern of wax characters may be slightly different from that of the cavities in the zinc plate. Finally, when the rice paper is applied to the surface of the mold tool, the transfer of the wax to the mold tool surface may also result in minor differences between the character pattern on the mold tool surface and the pattern of characters on the GR negative. Despite these minor differences, the character pattern on the mold tool surface will generally match the pattern of characters on the GR negative. Thus, if different patterns are desired on the mold tool surface, corresponding changes can be made to the GR negative that will ultimately be reflected in changes to the pattern on the mold tool surface.

At step 28, a caustic material, for example ferric chloride acid, is applied to the mold tool surface to etch the unmasked portion of the tool surface, thereby leaving the masked portion raised above the unmasked portion. As with the etching of the zinc plate, the strength of the acid solution, the time it is in contact with the surface of the mold tool, and the temperature of the solution, may all have an effect on the amount of material that is removed. In addition, as with the zinc plate, the mold tool could be laser etched to remove the material, as an alternative to using acid. The masked portion of the mold tool surface creates a plurality of raised portions, the height of which is directly dependent on the amount of material removed from the unmasked portion of the tool surface. Because the mold tool surface is a negative of the surface that will be created in a polymeric component produced with the mold tool, the height of the raised portions corresponds to the depth of cavities within such a polymeric component. Therefore, to vary the depth of the cavities in the polymeric component, more or less material can be removed from the surface of the mold tool. It is worth noting that although the size, shape and pattern of cavities formed in a polymeric component will generally correspond to the size, shape and pattern of the raised portions on the mold tool surface, they will generally not be an exact match. This is due, at least in part, to shrinkage of the polymeric material as it cools and solidifies.

Steps 30, 32 show cleaning steps that may be performed to clean the surface of the mold tool. For example, at step 30, the surface of the mold tool can be cleaned with solvents, and then at step 32, the surface of the mold tool can be blasted with a common grade of abrasive bead. Whether it is desirable to perform the cleaning steps 30, 32, depends in part on how material is removed from the surface of the mold tool. For example, if laser etching is used to removed material, rather than an acid wash, the cleaning steps 30, 32 may not be necessary. Moreover, the surface of the mold tool may be optionally inspected in between various steps to ensure that the tool surface pattern matches some predetermined standard.

Once the raised portions have been formed into the tool surface, a polymeric component can be produced having a reduced gloss surface obtaining a plurality of cavities corresponding to the raised portions on the mold tool surface. Additional preparation of the mold tool surface, however, can produce an even greater reduction in the gloss of a corresponding polymeric component. For example, at step 34, the mold tool surface, and in particular the area containing the raised portions, is blasted at least twice with increasingly smaller abrasive beads. One method found to be effective is to start by blasting the mold tool surface with a 60 mesh size abrasive, followed by a second blast using an 80 mesh size abrasive. Finally, the mold tool surface is blasted a third time using a 240 size mesh abrasive. Unlike traditional methods of achieving a reduced gloss finish on a polymeric component, the present invention does not rely on the use of blasting the mold tool surface to achieve the desired end. Rather, the raised portions of the mold tool surface themselves provide a reduced gloss finish on a polymeric component. Blasting the mold tool surface after the raised portions are created, helps to augment the reduced gloss appearance of the polymeric component.

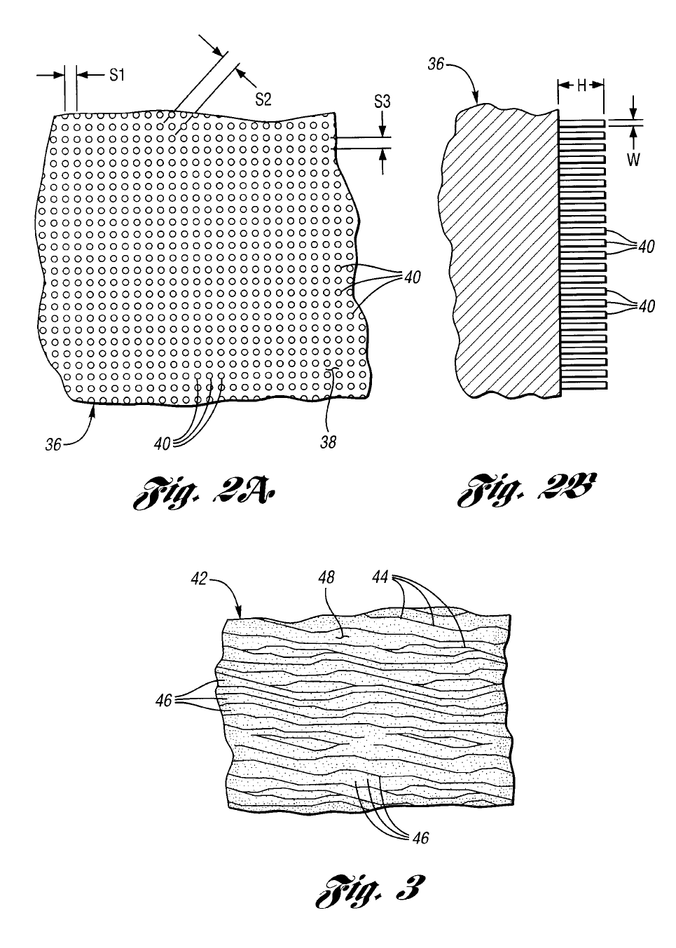

FIGS. 2A and 2B show a portion of a mold tool 36 made in accordance with the present invention. The mold tool 36 includes a surface 38 having formed thereon a plurality of raised portions 40. As shown in FIGS. 2A and 2B, the raised portions 40 are generally cylindrical, and as particularly shown in FIG. 2A, have a cross section that is generally circular. It is important to note that as used herein, the term “cylindrical” is not limited to a right circular cylinder, but rather, includes non-circular cross sections, such as those that are oval or polygonal.

As shown in FIG. 2B, each of the raised portions 40 has a width (W) which may vary somewhat between all of the raised portions 40. Indeed, if the raised portions 40 are not circular, there will be different widths that can be measured across different areas of each raised portion 40. In the embodiment shown in FIG. 2B, each of the raised portions has a maximum width, and the average maximum width of all of the raised portions 40 is less than 350 μm. Although differently sized raised portions can be used to achieve different levels of reduced gloss on a polymeric component, using a mold tool, such as the mold tool 36, having raised portions with an average maximum width of less than 350 μm, has been shown to be effective at reducing the gloss on a surface of a polymeric component produced with the mold tool.

Although the present invention contemplates the use of raised portions having different cross-sectional shapes and sizes, the use of raised portions having generally circular cross sections, and an average maximum width of about 250 μm, has been found to be effective to achieve a reduced gloss appearance on the surface of a polymeric component. Although the maximum width of the raised portions may vary from the 250 μm average—e.g., from 225 μm to 275 μm—having a tight tolerance may be desirable. Thus, the use of raised portions on the surface of a mold tool having generally circular cross sections and an average maximum width of approximately 250 μm, where the width of each raised portion is held to +/−3 μm, has been found particularly effective in some applications, such as for vehicle trim components.

FIG. 3 shows a portion of a vehicle trim component 42, such as may be used on a door panel or instrument panel of the vehicle. The trim component 42 includes an aesthetic pattern 44, which may be a simulated wood grain, leather grain, or some other aesthetic pattern. The pattern 44 can be etched into the surface of a mold tool, such as the surface 38 of the mold tool 36 shown in FIG. 2A. A variety of methods can be used to place the aesthetic pattern in the surface of the mold tool, including the etching technique discussed above in reference to the gloss reducing pattern. That is, steps 10-28, shown in FIG. 1, can be used to provide an aesthetic pattern in the surface of a mold tool, where the aesthetic pattern is provided on a negative and used in step 10, in place of the GR negative. The trim component 42 is made from a thermoplastic polyolefin (TPO), though the present invention may be used with other polymeric materials. For example, materials such as polypropylene, acrylonitrile butadiene styrene (ABS), and polycarbonate ABS (PC-ABS), just to name a few, may be used with the present invention.

Also shown in FIG. 3 is a plurality of cavities 46 which are formed in a surface 48 of the trim component 46. As shown in FIG. 3, the cavities 46 are small enough to provide little or no interference with the pleasing look of the aesthetic pattern 44. This is one of the advantages of the present invention, which provides a gloss reduction on a surface of a polymeric component, such as the component 42, without detracting from the aesthetics of the component, or interfering with other designs on, or molded into, the surface. As discussed above, many polymeric materials will shrink as they cool. Therefore, the cavities 46 in the trim component 42 may be even smaller than the corresponding raised portions on the mold tool in which the component was produced.

In addition to the width of the raised portions, the height and spacing of the raised portions can also be chosen to provide varying degrees of gloss reduction on the surface of a polymeric component. As shown in FIG. 2A, the raised portions 40 are arranged very close to one another, such that there is a high density of the raised portions 40 per square inch of area on the surface 38 of the mold tool 36. The density of the raised portions 40 is a function not only of their width, but also the spacing between them. As shown in FIG. 2A, the dimensions S1, S2 and S3 represent the distance between adjacent raised portions 40 as measured from their approximate centers. Using raised portions having relatively small widths, such as less than 350 μm, and an average spacing of less than 450 μm, the raised portions can be configured in a tool surface pattern such that the raised portion density is greater than 6,000 raised portions per square inch.

In addition to the width of the raised portions, the spacing between them, and their density, the height of the raised portions can also be varied to provide cavities of greater or lesser depth in a corresponding polymeric component. When an etching process, such as the process illustrated in FIG. 1, is used to form the raised portions in the surface of the mold tool, the height of the raised portions will be dependent on the amount of material removed from the surface of the mold tool. Depending on the application, it may be desirable to have cavities in the polymeric component of a particular depth. The depth of cavities, such as the cavities 46 in the trim component 42, may not exactly match the height (H) of the raised portions 40 (see FIG. 2B), because of shrinkage of the polymeric material; however, the height of the raised portions 40 can be varied to achieve the desired depth, and the desired gloss reduction on the polymeric component.

In one application, it has been found that using raised portions, such as the raised portions 40 on the mold tool 36, having a height of approximately 40 μm, is effective to provide a reduced gloss finish on a vehicle instrument panel, particularly when the raised portions have an average width of about 250 μm and an average spacing of about 375 μm. Of course, each of these parameters can be varied to suit a particular application. Because the present invention employs the use of raised portions on the surface of the mold tool, instead of just bead blasting the mold tool surface, the life of the mold tool is significantly increased, and the number of parts that can be produced between maintenance downtime is also increased. Thus, the present invention provides distinct advantages over previous methods used to provide a reduced gloss finish on a polymeric component.

While the best mode for carrying out the invention has been described in detail, those familiar with the art to which this invention relates will recognize various alternative designs and embodiments for practicing the invention as defined by the following claims.

1. A method for producing a mold tool to achieve a reduced gloss appearance on a surface of a polymeric component produced with the tool, the method comprising:
masking a portion of a surface of the tool with a plurality of characters arranged in a character pattern; and
applying a caustic material to the tool surface, thereby removing material from an unmasked portion of the tool surface and leaving the masked portion raised above the unmasked portion and forming a tool surface pattern generally matching the character pattern, the tool surface pattern including a plurality of raised portions, each of the raised portions having a maximum width, the average maximum width of the raised portions being less than 350 μm, the tool surface pattern thereby providing a reduced gloss appearance on a corresponding surface of a polymeric component produced with the tool.

2. The method of claim 1, wherein each of the raised portions has a height, and the average height of the raised portions is approximately 40 μm.

3. The method of claim 1, wherein the tool surface pattern has an average spacing of less than 450 μm, the spacing of the tool surface pattern being defined as the distance from an approximate center of one raised portion to an approximate center of an adjacent raised portion.

4. The method of claim 1, wherein the tool surface pattern has a raised portion density greater than 6000 raised portions per square inch.

5. The method of claim 1, wherein the raised portions generally cylindrical and each of the raised portions has a maximum width in the range of 225 μm to 275 μm.

6. The method of claim 1, further comprising providing the tool surface with an aesthetic pattern configured to provide a corresponding aesthetic pattern to a corresponding surface of a polymeric component produced with the tool.

7. The method of claim 1, further comprising:
forming in a surface of a metallic plate a plurality of cavities in a pattern corresponding to the character pattern;
at least partially filling at least some of the cavities with spreadable material;
applying paper to the metallic plate over the at least partially filled cavities; and
removing the paper from the metallic plate, thereby removing at least some of the spreadable material from the at least partially filled cavities, and
wherein masking a portion of the tool surface includes disposing the paper on the tool surface such that the spreadable material on the paper contacts the tool surface.

8. The method of claim 7, wherein forming the cavities in the surface of the metallic plate includes:
masking a portion of the surface of the metallic plate, thereby leaving a portion of the metallic plate surface unmasked, the unmasked portion of the metallic plate surface being configured in the pattern corresponding to the character pattern, and
applying a caustic material to the unmasked portion of the metallic plate surface such that material is removed at a rate of approximately 25 μm per three minutes.

9. The method of claim 7, wherein forming the cavities in the surface of the metallic plate includes laser etching the cavities.

10. The method of claim 7, wherein each of the cavities has a maximum depth, and the average maximum depth of the cavities is approximately 37 μm.

11. The method of claim 1, further comprising:
blasting the tool surface with an abrasive material at least twice after the caustic material is applied, each subsequent blasting using a smaller abrasive size than the previous blasting.

12. The method of claim 11, wherein blasting the tool surface includes blasting the tool surface a first time using a 60 mesh size abrasive, blasting the tool a second time using an 80 mesh size abrasive, and blasting the tool a third time using a 240 mesh size abrasive.

13. A method for producing a polymeric component having a surface with a reduced gloss appearance, comprising:
providing a mold tool having a surface including a plurality of raised portions configured in a tool surface pattern, each of the raised portions having a maximum width, the average maximum width of the raised portions being less than 350 μm; and
disposing a polymeric material within the mold tool such that at least some of the polymeric material contacts the tool surface, thereby forming in the polymeric material a corresponding surface having a pattern generally matching the tool surface pattern and having a reduced gloss appearance.

14. The method of claim 13, wherein each of the raised portions has a height, and the average height of the raised portions is approximately 40 μm.

15. The method of claim 13, wherein the tool surface pattern has an average spacing of less than 450 μm, the spacing of the tool surface pattern being defined as the distance from an approximate center of one raised portion to an approximate center of an adjacent raised portion.

16. The method of claim 13, wherein the tool surface pattern has a raised portion density greater than 6000 raised portions per square inch.

17. The method of claim 13, wherein the raised portions are generally cylindrical and each of the raised portions has a maximum width in the range of 225 μm to 275 μm.

18. A polymeric component having a reduced gloss appearance, the polymeric component comprising:
a surface; and
a plurality of cavities formed in at least a portion of the surface, each of the cavities having a maximum width, the average maximum width of the cavities being less than 350 μm, the cavities having a density greater than 6000 cavities per square inch, thereby providing a reduced gloss appearance on the surface.

19. The polymeric component of claim 18, wherein the surface includes an aesthetic pattern formed therein, the aesthetic pattern being in addition to the cavities.

20. The polymeric component of claim 18, wherein the polymeric component is an automotive trim component.
